(19) United States
(12) Patent Application Publication
(10) Pub. No.: US 2002/0198745 A1
(43) Pub. Date: Dec. 26, 2002

(54) System and method for completing and distributing electronic certificates

(76) Inventors: Edward B. Scheinuk, Metairie, LA (US); Jim Sanders, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/207,436

(22) Filed: Jul. 26, 2002

Related U.S. Application Data
(62) Division of application No. 09/406,093, filed on Sep. 24, 1999.

(51) Int. Cl. G06F 17/60

(52) U.S. Cl. 705/4

(57) ABSTRACT

A system and method for maintaining and transmitting certificates of insurance. The system includes a certificate server which is in data communication with one or more agency computers and one or more insured computers. An insurance agent using one or more of the agency computers can create a pro forma certificate of insurance that is transmitted to the certificate server. The agent can configure the certificate server to allow an insured to request issuance of one or more certificates of insurance regarding an insurance policy that is held by the insured. Further, the agent can prepare one or more replacement certificates and request the certificate server to automatically transmit the replacement certificates to existing certificate holders. The certificate server provides security to ensure that unauthorized individuals do not issue certificates. Further, insureds can use the certificate server to request information regarding each of the certificates that have been issued with respect to insurance policies that are held by the insured.

### RELATED APPLICATIONS

This patent application is a divisional of U.S. application Ser. No. 09/406,093 filed on Sep. 24, 1999. This patent application is related to U.S. application Ser. No. 09/404,973, entitled “SYSTEM AND METHOD OF GENERATING ELECTRONIC FORMS”; U.S. application Ser. No. 09/404,974, entitled “SYSTEM AND METHOD OF GENERATING ELECTRONIC FORMS USING A COMPUTER NETWORK”; U.S. application Ser. No. 09/404,970, entitled “SYSTEM AND METHOD OF SEARCHING FOR ELECTRONIC FORMS”; U.S. application Ser. No. 09/405,365, entitled “SYSTEM AND METHOD OF COMPLETING AN ELECTRONIC FORM INCLUDING AN ELECTRONIC ATTACHMENT” and U.S. application Ser. No. 09/405,355, entitled “SYSTEM AND METHOD FOR AUDITING ELECTRONIC FORMS”, which were filed concurrently on Sep. 24, 1999. Each of the foregoing are incorporated by reference in their entirety.

### BACKGROUND OF THE INVENTION

1. Field of the Invention

The invention relates to certificates of insurance. More specifically, the invention relates to a system and method for maintaining and transmitting certificates of insurance.

2. Description of the Related Technology

Certificates of insurance are commonly used in the insurance industry to provide individuals with proof that an insured has adequate insurance. Such certificates are commonly used in several industries, such as building construction, food processors, service agencies, and retail chains. Traditionally, upon a request for a certificate, an insured contacts his insurance agent and requests the insurance agent to transmit a certificate of insurance to the requestor (“certificate holder”). The insurance agent prepares the certificate and sends the certificate to the certificate holder. As part of preparing the certificate for issuance, the insurance agent includes the insurance policy information and the address information of the certificate holder on the certificate. Further, the insurance agent records and stores the address information of the certificate holder such that the insurance agency can notify the certificate holder in case of any changes to the insurance policy.

One drawback that is associated with these traditional systems is that mistakes are often made as part of the manual process of creating the certificate of insurance. Further, significantly, it has been found that some insureds regularly request the issuance of over 50 certificates a year. Due to the large number of certificates that are issued with respect to selected clients, significant agency time is expended in preparing these certificates. Further, if a change occurs with respect to the insured's policy, the insurance agent traditionally had to manually prepare and transmit new certificates of insurance for each of the certificate holders. The process for manually issuing certificates can require the assistance of several employees over one or more days.

Accordingly, there is a need for a system and method of automatically maintaining certificates of insurance which reduces the burden on insurance agency personnel.

### SUMMARY OF THE INVENTION

One aspect of the present invention includes a method of generating electronic forms, the method comprising receiving, via a computer network, a digital image of an electronic form, merging one or more form recipient data items with the digital image, and transmitting the merged electronic form to a remote location. The electronic form is selected from a group of electronic forms for business, insurance, medical, transportation, legal, or real estate.

Another aspect of the present invention includes a system for generating insurance certificates, the system comprising a first database comprising policy data items that are associated with policy information for a plurality of insureds; an agency computing device which receives policy data items, from the first database, and a digital representation of an insurance certificate form, wherein the agency computing device inserts one or more policy data items in the digital representation of the insurance certificate form to generate an electronic insurance certificate for each insured; a computer network connected to the agency computing device; a client computing device connected to the computer network; and a certificate server connected to the client computing device via the computer network, wherein the certificate server maintains one or more electronic insurance certificates received from the agency computing device, wherein, upon a request from the client computing device, the certificate server merges one or more certificate holder information items regarding a certificate holder with a corresponding electronic insurance certificate to produce a completed insurance certificate, and wherein the certificate server automatically transmits the completed insurance certificate to the certificate holder.

Another aspect of the present invention includes a system for generating insurance certificates, the system comprising a computer network; an agency computing device connected to the computer network and configured to insert one or more policy data items that are associated with policy information for a plurality of insureds in a digital representation of an insurance certificate form to generate an electronic insurance certificate for each insured; a client computing device connected to the computer network; and a certificate server connected to the client computing device via the computer network, wherein the certificate server maintains one or more of the electronic insurance certificates received from the agency computing device, wherein, upon a request from the client computing device, the certificate server merges one or more certificate holder information items with a corresponding electronic insurance certificate to produce a completed insurance certificate, and wherein the certificate server automatically transmits the completed insurance certificate to the certificate holder.

Another aspect of the present invention includes a system for generating insurance certificates, the system comprising a computer network; a client computing device connected to the computer network, and configured to provide certificate holder information; and a certificate server connected to the client computing device via the computer network, and configured to provide certificate holder information, wherein the certificate server maintains one or more electronic insurance certificates, wherein, upon a request from the client computing device, the certificate server merges one or more certificate holder information items with a corresponding electronic insurance certificate to produce a final insurance certificate, and wherein the certificate server automatically transmits the final insurance certificate to the certificate holder.

Yet another aspect of the present invention includes a method of generating insurance certificates, the method comprising providing an electronic insurance certificate form; inserting one or more policy data items that are associated with policy information for an insured in the electronic insurance certificate form to generate an electronic insurance certificate; storing the electronic insurance certificate in a first database; merging one or more certificate holder data items that are associated with a certificate holder with the electronic insurance certificate to generate a completed insurance certificate; and transmitting the completed insurance certificate to a certificate holder at a remote location via a network.

### BRIEF DESCRIPTION OF THE DRAWINGS

FIG. 1 is a block diagram illustrating a certificate management system which includes one or more agency computers, one or more insured computers and a certificate server.

FIG. 2 is a block diagram illustrating in further detail the certificate management system shown in FIG. 1.

FIG. 3 is a data flow diagram showing how a completed certificate of insurance is prepared.

FIG. 4 is a block diagram illustrating an exemplary data schema that may be used in connection with the certificate management system shown in FIG. 1.

FIG. 5 is a high level flowchart illustrating a process for using the certificate management system shown in FIG. 1.

FIG. 6 is flowchart illustrating a process for logging into the certificate server of FIG. 1.

FIG. 7 is a flowchart illustrating a loading process for loading a certificate of insurance from the agency computer of FIG. 1 to the certificate server of FIG. 1.

FIG. 8 is a flowchart illustrating a transmitting process for sending a certificate of insurance from the certificate server to one or more certificate holders.

FIGS. 9A and 9B are collectively a flowchart illustrating a process for renewing a certificate of insurance.

FIG. 10 is a flowchart illustrating a process for replacing one certificate of insurance with another.

FIG. 11 is an exemplary screen display for receiving information regarding a certificate holder that wants a certificate of insurance.

FIG. 12 is an exemplary screen display for receiving search criteria regarding the certificates of insurance that have been issued by the certificate server of FIG. 1.

FIG. 13 is a copy of an exemplary certificate of insurance that is transmitted by the certificate server of FIG. 1 to a certificate holder.

FIG. 14 is a copy of an exemplary addendum that is transmitted by the certificate server of FIG. 1 to a certificate holder.

FIG. 15 is a block diagram illustrating one embodiment of the certificate management system shown in FIG. 1.

### DETAILED DESCRIPTION OF EMBODIMENTS OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

### System Overview

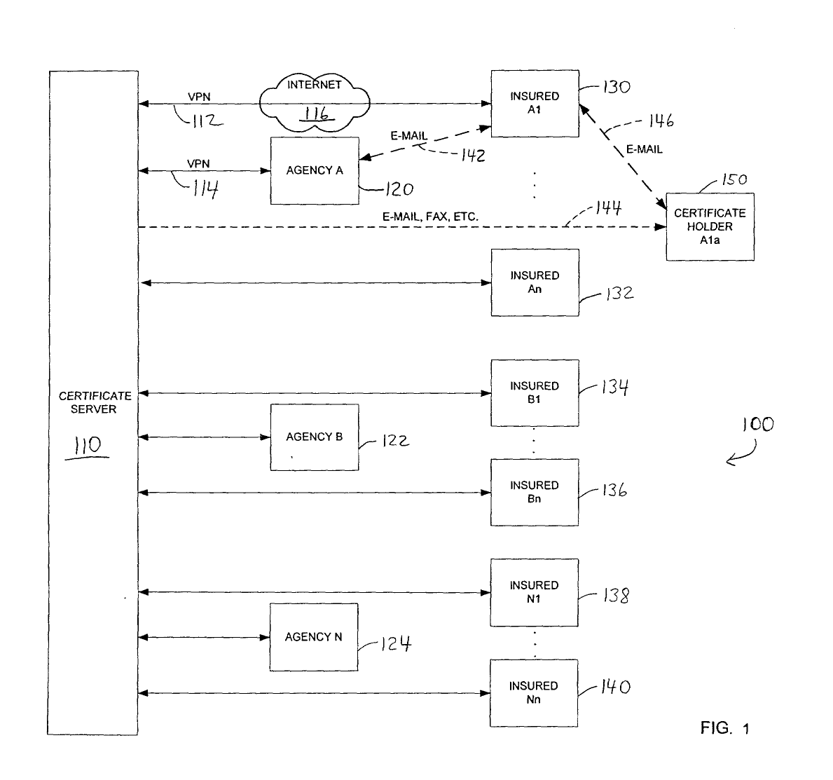

FIG. 1 is a block diagram illustrating a certificate management system 100 according to the present invention. The certificate management system 100 allows for the maintenance and automatic transmission of certificates of insurance to one or more certificate holders 150.

The certificate management system 100 comprises a number of agency computers 120, 122, 124. It is noted that although only three agency computers 120, 122, 124 are shown in FIG. 1, the certificate management system 100 can include thousands of agency computers and upwards. Each of the agency computers 120, 122, 124 may be used to create and modify various certificates of insurance. Typically, one or more of the agency computers 120, 122, 124 is associated with a selected insurance agency. For example, ACME insurance agency may have a number of computers that are each used by agency personnel.

The agency computers 120, 122, 124 are each connected to a certificate server 110 via a network 114. The certificate server 110 maintains certificates of insurance which have been provided by the agency computers 120, 122, 124 for selected insureds. Further, the certificate management system 100 includes a number of insured computers 130, 132, 134, 136, 138, 140. It is noted that although only six insured computers are shown in FIG. 1, the certificate management system 100 can include thousands of insured computers and upwards. Typically, one or more of the insured computers is associated with a selected insured. The insured computers 130, 132, 134, 136, 138, 140, are each connected to the certificate server via a network 112.

Optionally, the certificate server 110, the agency computers 120, 122, 124, and the insured computers 130, 132, 134, 136, 138, 140, or selected ones thereof, may be integrated on a single computer platform. Further, it is noted the certificate server 110, the agency computers 120, 122, 124, and the insured computers 130, 132, 134, 136, 138, 140 may not necessarily be located in the same room, building or complex. In fact, the certificate server 110, the agency computers 120, 122, 124, and the insured computers 130, 132, 134, 136, 138, 140 could each be located in different states or countries. Further, in one embodiment of the invention, the certificate server 110 is operated and maintained by an independent agency that is separate legal entity apart from the insurance agencies.

The certificate server 110, the agency computers 120, 122, 124, and the insured computers 130, 132, 134, 136, 138, 140 may each have any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. Furthermore, the certificate server 110, the agency computers 120, 122, 124, and the insured computers 130, 132, 134, 136, 138, 140 may be desktop, server, portable, hand-held, set-top, or any other desired type of configuration. Furthermore, the certificate server 110, the agency computers 120, 122, 124, and the insured computers 130, 132, 134, 136, 138, 140 each may be used in connection with various operating systems such as: UNIX, LINUX, Disk Operating System (DOS), OS/2, Windows 3.X, Windows 95, Windows 98, and Windows NT. In one embodiment of the certificate management system 100, each of the insured computers 130, 132, 134, 136, 138, 140 include a network browser, such as Internet Explorer, that is used to access the certificate server 110.

The networks 112, 114 may include any type of electronically connected group of computers including, for instance, the following networks: a virtual private network, an Internet 116, intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). As used herein, the network may include network variations such as public Internet, a private Internet, a secure Internet, a private network, a public network, a virtual private network (VPN), a value-added network, an intranet, and the like.

The certificate server 110 is in data communication via a data communication link 144 with the certificate holder 150. Upon a request from either one of the insured computers 130, 132, 134, 136, 138, 140, the certificate computer 110 transmits one or more certificates of insurance via e-mail, facsimile, or download to one or more of the certificate holders 150. The request may be via the network 112 or via an e-mail path or link 142 to agency 120 and then further via network 114, for example. Other ways of providing the request, such as via fax or telephone call to the agency may be utilized in other embodiments. In certain embodiments, the certificate holder 150 may communicate with an insured computer (e.g., 130) via an e-mail path 146 to make a request and/or receive one or more certificates of insurance. The certificate server 110 may optionally provide certificate(s) via network 114 and links 142 and 146.

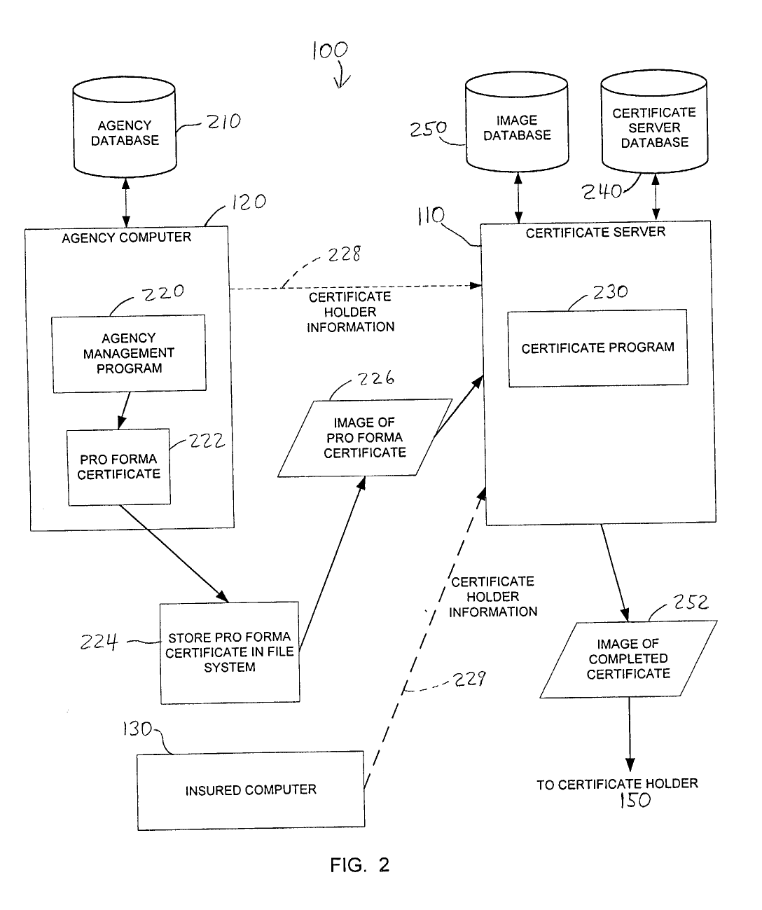

FIG. 2 is a block diagram illustrating in further detail the certificate management system 100 shown in FIG. 1. It is noted that only one of the agency computers 120, 122, 124, namely, agency computer 120, and only one of the insured computers 130, 132, 134, 136, 138, 140, namely, insured computer 130 is described below and shown in FIG. 2, the follow description also describes these other computers. The agency computer 120 includes an agency management program 220 that is used to create one or more certificates of insurance. The agency computer 120 also includes an agency database 210 that is used to store various items of information regarding insurance policies and insureds. For example, the agency database 210 includes among other items: the address information for the insured, address information for the insurance agency, the limits that are associated with the insurance policies of the insured, the policy numbers of the insured, the effective dates of the insurance policy, and the name of the insurance carrier that issued the insurance policy.

The agency management program 220 creates, upon a request from an agent one or more pro forma certificates of insurance 222 for a selected insured based upon information that is stored in the agency database 210.

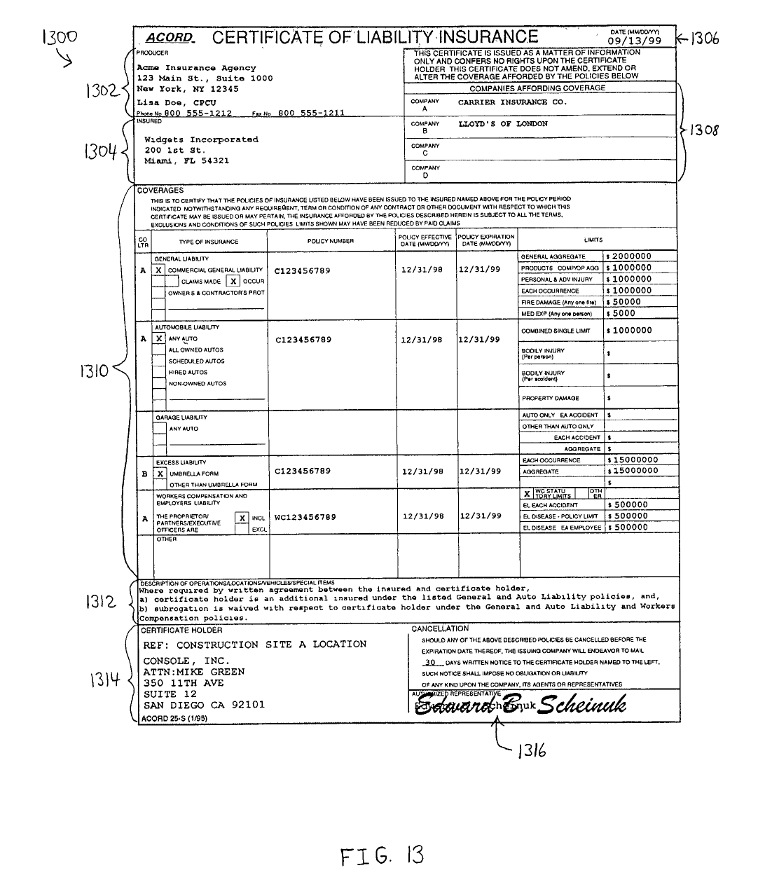

The pro forma certificate of insurance 222 typically includes address information for the insured, address information for the insurance agency, the limits that are associated with the insurance policy of the insured, the policy number of the insured, the effective dates of the insurance policy, and the name of the insurance carrier. Notably, the pro forma certificate 220 does not necessarily include the name or address of any specific certificate holder. An example of a certificate of insurance (completely-filled in) is shown in FIG. 13.

After creation, the certificate is stored 224 as a digital image 226 in the file system of the agency computer 120. Further, the digital image 226 of the certificate of insurance is transmitted to the certificate server 110 via the network 114. Advantageously, since in one embodiment of the invention, the certificate of insurance is stored in the form of a bitmap or graphical format, it is difficult to improperly modify the contents of the certificate, e.g., policy information. If needed, one or more addenda may be prepared with respect to the certificate of insurance. An addendum is one or more extra pages that are associated with a certificate and that contain extra policy provisions which should be provided by the insurance agency to the certificate holder. It is noted that many commercial lines have complex restrictions and/or enhancements to coverage and this information is often included in the addendum.

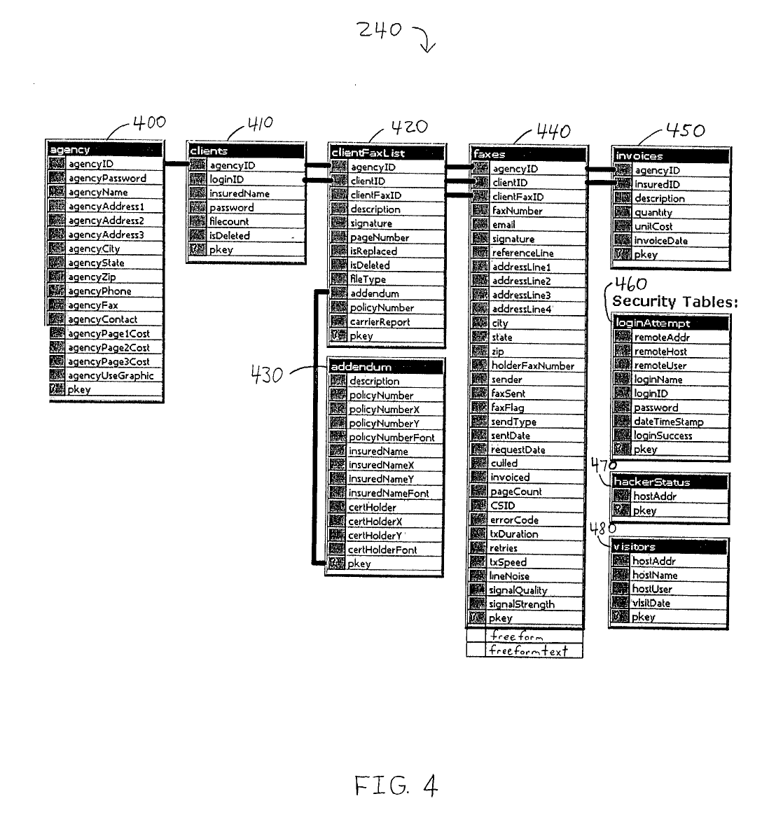

The certificate server 110 includes a certificate program 230. The certificate program 230 stores the digital image 226 in an image database 250. In one embodiment of the invention, the image database 250 is the file system of the certificate server 110. The certificate server 110 includes a certificate server database 240 that stores various items of information regarding the digital images 226. FIG. 4 set forth below describes in further detail the format of a database schema that is used in conjunction with the certificate server database 240.

The certificate program 230 is used by an insurance agent at the agency computer 120 or an insured at the insured computer to transmit one or more certificates of insurance to one or more of the certificate holders 150. The agent can configure the certificate server 110 to allow an insured to request one or more certificates of insurance regarding an insurance policy that is held by the insured. Further, the agent can prepare one or more replacement certificates and request the certificate server 110 to automatically transmit the replacement certificates to existing certificate holders.

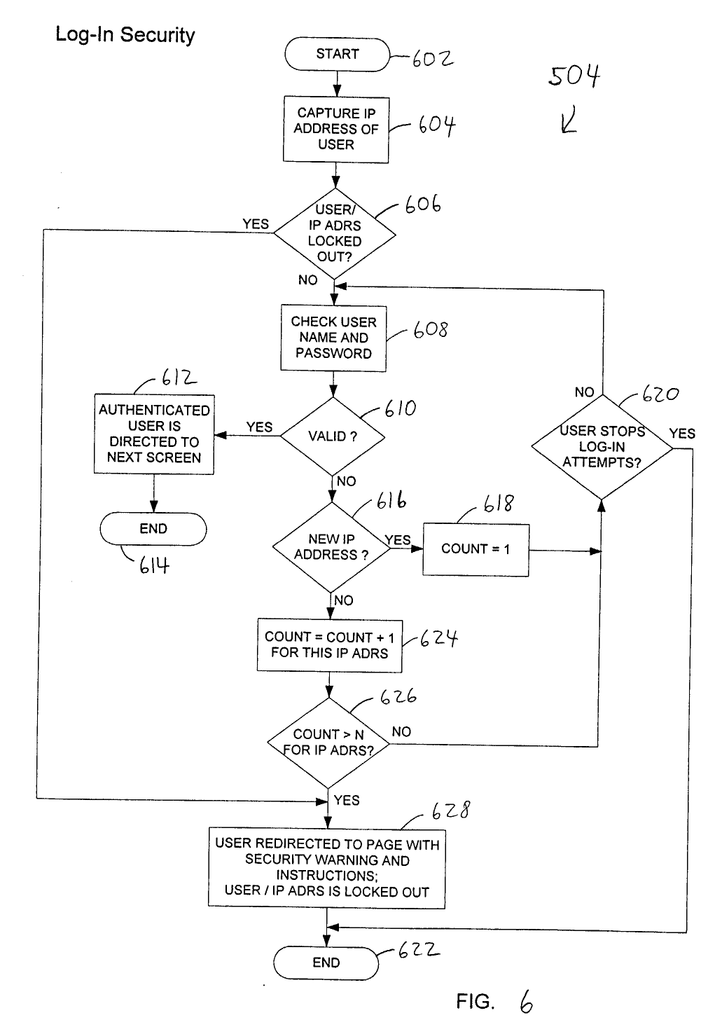

The process for selecting and transmitting a certificate of insurance is described in further detail below with reference to FIG. 6. However, in brief, the process is as follows. After a certificate is selected, the certificate server 110 merges the certificate holder information from the requester and transmits the merged image 252 of the document and any accompanying addenda to one or more of the certificate holders 150 (FIG. 1). The certificate server 110 allows the requester to selected the mode of transmission, i.e., fax, email, download, etc. Further, the certificate server 110 allows the requestor of the certificate of insurance to provide a free form digital text document which will be included in the transmission. The free form digital text can be advantageously used to store helpful information such as, for example, a list of a number of contractors or owners that are associated with a project.

As can be appreciated by a skilled technologist, the agency management program 220 and the certificate program 230 each comprise various sub-routines, procedures, definitional statements, and macros. In one embodiment of the invention, the agency management program 220 and the certificate program 230 are made available in a shareable dynamic link library. Furthermore, the management program 220 and the certificate program 230 may be written in any programming language such as C, C++, BASIC, Pascal, Java, and FORTRAN. C, C++, BASIC, Pascal, Java, and FORTRAN are industry standard programming languages for which many commercial compilers can be used to create executable code.

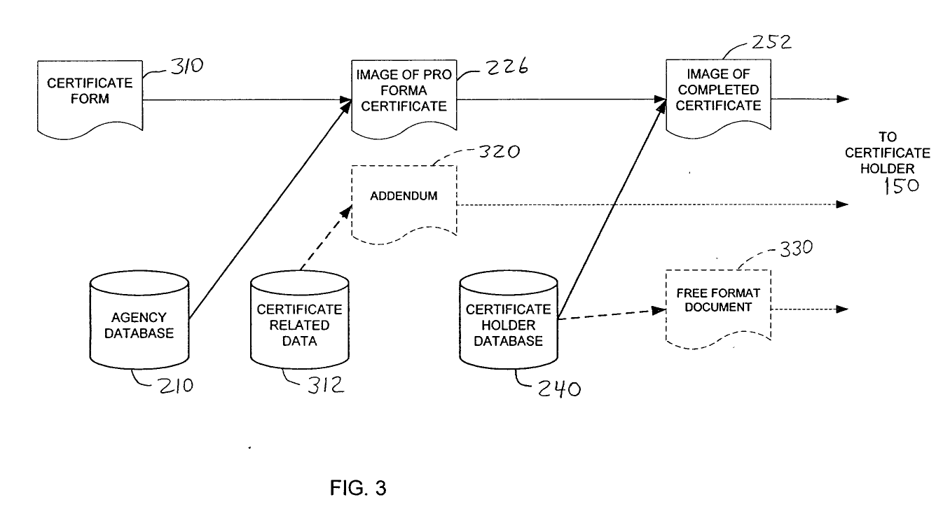

FIG. 3 is a data flow diagram showing how a completed certificate of insurance is prepared. FIG. 3 shows a certificate form 310 that in one embodiment resides on the agency computer 120 (FIG. 1). At the agency computer 120, information from the agency database 210 is merged with the certificate form 310 to create the pro forma image 226. Further, at the agency computer 120, one or more addenda 320 can be created based on certificate related data 312 and subsequently associated with the pro forma image 226. The pro forma image 226 and the addendum 320 are transmitted via the network 114 to the certificate server 110. At the certificate server 110, upon a request from a user, the completed image 252 of the certificate is created using information provided by the user or the certificate holder database 240.

At the certificate server 110, one or more certificates can be issued to the certificate holders 150, as requested by the insureds along with optionally one or more addendum 320 and a free format document 330. For example, if one individual is in need of a certificate, an insured can input the certificate holder information and have a certificate directly transmitted to the certificate holder. Further, for example, if each of the certificates that have been issued by an insured agency need to be replaced, the certificate server 110 can retrieve the names of each of the current certificate holders from the certificate server database 240 and transmit new certificates to each of certificate holders. In one embodiment of the invention, for security and trust concerns, the insurance agent and not the insured is allowed to provide the free format document 330 with regard to a selected transmission.

FIG. 4 is a diagram illustrating a database schema 240′ for the certificate server database 240. The database schema 240′ includes a number of tables that are used to store information regarding each of the certificates of insurance that is maintained by the certificate server 120 (FIG. 1).

The database schema 240′ includes an agency table 400, a clients table 410, a clientFaxList table 420, an addendum table 430, a faxes table 440, an invoices tables 450, a login attempt table 460, a hacker status table 470, and a visitors table 480. It is noted that the tables of the database schema 240′ have been provided for exemplary purposes and that depending on the embodiments, selected tables and/or selected fields from the tables may be omitted from the database schema, and that other tables and/or fields in selected tables may be added.

The agency table 400 includes the data regarding each of the insurance agencies that are using the certificate server 110 (FIG. 1). Table 1, set forth below, includes a description of each of the fields in the agency table 400. Further, Appendix A includes exemplary data for the agency table 400. Referring to Appendix A, the only entry in the table includes information regarding an insurance agency named “Acme.” It is noted that the agency table 400 can include information for more than one insurance agency. Each row in the agency table shown in Appendix A corresponds to a selected agency.

TABLE 1

| Field Name | Description |
|---|---|
| agencyID | The agency login ID used by the insurance agency |
| | personnel to gain access to the certificate server. |
| | The agencyID is one of several fields that are used |
| | by the certificate server to relate the records found |
| | in the various tables of the database. |
| agencyPassword | The insurance agency password. |
| agencyName | The name of the insurance agency. The name is |
| | used by the certificate server in automated reporting, |
| | invoicing, mailing, facsimile telephone transmis- |
| | sions, and transmitting e-mail. |
| agencyAddress1 | The first line of the address of the insurance agency. |
| agencyAddress2 | The second line of the address of the insurance |
| | agency. |
| agencyAddress3 | The third line of the address of the insurance |
| | agency. |
| agencyCity | The city of the insurance agency. |
| agencyState | The state of the insurance agency. |
| agencyZip | The zip code of the insurance agency. |
| agencyPhone | The phone number of the insurance agency. |
| agencyFax | The fax number of the insurance agency. |
| agencyContact | A contact person at the insurance agency. |
| agencyEmail | The e-mail address of the insurance agency. |
| agencyPage1Cost | The price associated with transmitting the first page |
| | of the certificate of insurance. |
| agencyPage2Cost | The price associated with transmitting the second |
| | page of the certificate of insurance. |
| agencyPage3Cost | The price associated with transmitting pages of the |
| | certificate of insurance beyond the first two pages. |
| agencyUseGraphic | The name of a graphic file that includes a logo that |
| | is associated with the insurance agency. The logo is |
| | presented to insurance agency personnel and the |
| | insureds that are associated with the insurance |
| | agency personnel when the user logs on. |
| pkey | The primary key for this table as per ANSI 92 SQL |
| | standards for Database Management Systems |
| | (DBMS) |

The clients table 410 includes data regarding each of the clients (“insureds”) that are associated with the insurance agencies identified in the agency table 400. Table 2, set forth below, includes a description of each of the fields in the client table 410.

Further, Appendix B includes exemplary data for the clients table 410. Each row in the client table 410 corresponds to a selected insured. For example, the first row in the client table 410 includes information regarding an insured name Gadgets Worldwide Incorporated (“GWI”).

TABLE 2

| Field Name | Description |
|---|---|
| agencyID | The agency login ID used by the insurance agency |
| | personnel to gain access to the certificate server. The |
| | agencyID is one of several fields that are used by the |
| | certificate server to relate the records found in the various |
| | tables of the database. |
| loginID | The insured loginID used by insured personnel to gain |
| | access to the certificate server. The loginID is the second of |
| | three fields that are used by the certificate server to relate |
| | the records found in the various tables of the database. |
| insuredName | The name of the insured. |
| password | The password of the insured. |
| filecount | The number of certificates of insurance that have been |
| | issued with respect to the insured identified by the loginID. |
| isDeleted | A Boolean flag. If the value of this column is true, the |
| | insured identified by the loginID has been deleted from use |
| | by the insurance agent. |
| pkey | The Primary Key for this table as per ANSI 92 SQL |
| | standards for Database Management Systems (DBMS). |

The clientFaxList table 420 maintains information regarding the certificates of insurance that are stored in the certificate server. Each row of data represents one page of a certificate of insurance. Accordingly, a two page certificate of insurance occupies two rows of the clientFaxList table.

Table 3, set forth below, includes a description of each of the fields in the clientFaxList table 420. Further, Appendix C includes exemplary data for the clientFaxList table 420. In one embodiment of the invention, the location of a digital image of a certificate of insurance is identified by the fields agencyID, clientID, clientFaxID. In this embodiment, these three fields, when concatenated, identify the name of a file containing the digital image of the certificate of insurance. It is to be appreciated by a skilled technologist that other methods exist for identifying the location of one or more files in a database.

TABLE 3

| Field Name | Description |
|---|---|
| agencyID | The agency login ID used by the insurance agency |
| | personnel to gain access to the certificate server. The |
| | agencyID is the first of three fields that are used by the |
| | certificate server to relate the records found in the various |
| | tables of the database. |
| clientID | The insurance agency password. The clientID is the |
| | second of three fields that are used by the certificate |
| | server to relate the records found in the various tables of |
| | the database. |
| clientFaxID | The insured's login ID used by the insured to gain access |
| | to the certificate server. The clientID is the third of three |
| | fields that are used by the certificate server to relate the |
| | records found in the various tables of the database. |
| description | A brief description regarding the certificate of insurance |
| | that is displayed to the insured or the insurance agent to |
| | facilitate the selection of an appropriate certificate of |
| | insurance. |
| signature | The location of an image of the signature of the insurance |
| | agent who produced the insurance policy. The signature |
| | is converted into a scripting font that the system signs on |
| | the certificate of insurance upon issuance and transmis- |
| | sion of a certificate of insurance from the system servers |
| | to the receiver of the request to transmit. |
| pageNumber | The page number of a page in a multi-page certificate of |
| | insurance. |
| isReplaced | A Boolean flag. Upon the uploading of a replaced certifi- |
| | cate of insurance, this field is marked as true. The certifi- |
| | cate server reads this field to determine whether the |
| | certificate server needs to reconvert the certificate of |
| | insurance from its original postscript graphics file, into |
| | the normal tiff (tagged image file format) type of |
| | graphics file that the system uses when performing |
| | graphics processing. |
| isDeleted | A Boolean flag. Upon deleting of a certificate of insur- |
| | ance, the certificate of insurance is not actually removed |
| | from the table as future reports and accounting balances |
| | must still use this data to show activity that occurred with |
| | this record prior to deletion. |
| OffsetY | A special case flag that indicates to the certificate server |
| | that image processing must be altered by a Cartesian |
| | coordinate Y offset from zero = left margin in an amount |
| | equal to the numeric value of this column. |
| addendum | A numeric value corresponding to the “pkey” column in |
| | the Addendum table. If non-zero, it indicates that an |
| | addendum is associated with this page. |
| policyNumber | The policy number of a certificate of insurance. |
| carrierReport | A Boolean flag indicating whether each issuance of a |
| | certificate of insurance by the certificate server should be |
| | included in a report for the carriers represented on the |
| | certificate of insurance. |
| pkey | The Primary Key for this table as per ANSI 92 SQL |
| | standards for Database Management Systems (DBMS) |

The addendum table 430 maintains information regarding one or more addenda that may be associated with each certificate of insurance. Addenda can include policy provisions and other information regarding the insurance policy.

Table 4, set forth below, includes a description of each of the fields in the addendum table 430. Further, Appendix D includes exemplary data for the addendum table 430. Each row in the addendum table 430 corresponds to one addendum. For example, the first row shown in the addendum table 430 of Appendix D includes information regarding an policy named “GECG840.” Further, this is an addendum for the policy identified by the first row of the clientFaxList table 420 shown in Appendix C.

TABLE 4

| Field Name | Description |
|---|---|
| description | A brief description of the addendum that is dis- |
| | played to the user regarding the addendum. The |
| | addendum description becomes a HTML hyperlink |
| | that a user may select to associate the addendum |
| | addendum with a selected certificate of insurance. |
| policyNumber | A Boolean flag indicating whether the certificate |
| | server will automatically print the policy number at |
| | the X and Y coordinates indicated by the 2 fields: |
| | policyNumberX and policyNumberY. The data |
| | corresponding to the policy number is stored in the |
| | policyNumber of the clientFaxList table record |
| | corresponding to the addendum. |
| policyNumberX | The position with respect to the top of the addendum |
| | wherein the policy number identified by the |
| | policyNumber field is to be displayed. |
| policyNumberY | The position with respect to the left side of the |
| | addendum wherein the policy number identified by |
| | the policyNumber field is to be displayed. |
| policyNumberFont | The font size of the policy number identified by the |
| | policyNumber field. |
| insuredName | A Boolean flag. If the flag is set to true, the |
| | addendum will include the insured name identified |
| | by the insuredName field in the Clients table on the |
| | addendum at the X, Y position found in the columns |
| | insuredNameX and insuredNameY. |
| insuredNameX | The position with respect to the top side of the |
| | addendum wherein the insured name is to be |
| | displayed. |
| insuredNameY | The position with respect to the left side of the |
| | addendum wherein the insured name is to be |
| | displayed. |
| insuredNameFont | The font size of the insured name. |
| certHolder | A Boolean flag. If true, the certificate system will |
| | print the certificate holder information in the certifi- |
| | cate holder box onto the addendum at the X, Y |
| | position found in the columns certHolderX and |
| | certHolderY whenever the addendum is sent. |
| certHolderX | The position with respect to the top side of the |
| | addendum wherein the certificate holder information |
| | is to be displayed. |
| certHolderY | The position with respect to the left side of the |
| | addendum wherein the certificate holder is to be |
| | displayed. |
| certHolderFont | The font size of the certificate holder information. |
| pkey | The primary key for this table as per ANSI 92 SQL |
| | standards for Database Management Systems |
| | (DBMS) |

The faxes table 440 stores the data that is used to transmit a certificate of insurance of a certificate holder via telephone, facsimile, mail, E-mail, and direct Internet download.

Table 5, set forth below, includes a description of each of the fields in the faxes table 440. Further, Appendix E includes exemplary data for the faxes table 440. Each row in the faxes table 440 corresponds to one certificate of insurance. For example, the first row shown in the faxes table 440 includes information regarding how to fax the certificate of insurance identified in the first row of the clientFaxList table 420 shown in Appendix C.

TABLE 5

| Field Name | Description |
|---|---|
| agencyID | The agency login ID used by the insurance agency |
| | personnel to gain access to the certificate server. The |
| | agencyID is one of several fields that are used by the |
| | certificate server to relate the records found in the |
| | various tables of the database. |
| clientID | The insurance agency password. The clientID is the |
| | second of three fields that are used by the certificate |
| | server to relate the records found in the various tables |
| | of the database. |
| clientFaxID | The insured's login ID used by the insured to gain |
| | access to the certificate server. The clientID is the third |
| | of three fields that are used by the certificate server to |
| | relate the records found in the various tables of the |
| | database. |
| faxNumber | The actual telephone facsimile number used to fax a |
| | certificate of insurance. If the certificate of insurance |
| | and accompanying material is to be only electronically |
| | mailed or downloaded, the field is empty. |
| email | The actual e-mail address used to e-mail a certificate |
| | of insurance. If the certificate of insurance and |
| | accompanying material is to be only faxed or down- |
| | loaded, the field is empty. |
| signature | The signature of an agent. |
| referenceLine | A reference line of text that the system user enters in |
| | the HTML form on the Web Site when requesting to |
| | send a certificate of insurance. |
| addressLine1 | The first line of the address of a certificate holder. This |
| | text is typically entered by an insured using the HTML |
| | form on the Web Site when the insured requests to |
| | send a certificate of insurance. |
| addressLine2 | The second line of the address of a certificate holder. |
| | This text is typically entered by an insured using the |
| | HTML form on the Web Site when the insured |
| | requests to send a certificate of insurance. |
| addressLine3 | The third line of the address of a certificate holder. |
| | This text is typically entered by an insured using the |
| | HTML form on the Web Site when the insured |
| | requests to send a certificate of insurance. |
| addressLine4 | The fourth line of the address of a certificate holder. |
| | This text is typically entered by an insured using the |
| | HTML form on the Web Site when the insured |
| | requests to send a certificate of insurance. |
| city | The city of the certificate holder. |
| state | The state of the certificate holder. |
| zip | The zip code of the certificate holder. |
| holderFaxNumber | The fax number of the certificate holder. |
| sender | Identifies the IP address of the machine of the user |
| | who requested a certificate of insurance. |
| faxSent | A Boolean flag indicating whether the certificate of |
| | insurance was successfully delivered. |
| faxFlag | A flag used by the certificate server to assist in |
| | queuing all telephone facsimile transmissions. |
| sendType | A description of the transmission type that was used |
| | for the certificate of insurance. |
| sentDate | The date and time that the certificate of insurance and |
| | accompanying documents were successfully delivered. |
| requestDate | The date and time that the certificate of insurance was |
| | requested by the user. |
| culled | A Boolean flag. If set to true, the certificate server |
| | has culled the certificate of insurance from the renewal |
| | list and the certificate of insurance is not resent upon |
| | the annual renewal retransmission of all certificates of |
| | insurance by an agent via the certificate server. |
| invoiced | Used by the invoicing system as a flag to assist in |
| | billing processing. |
| pageCount | The number of pages that were transmitted by the |
| | certificate server in transmitting the certificate of |
| | insurance and accompanying documents. |
| CSID | If the transmission is by facsimile telephone and the |
| | receiving facsimile was programmed with a CSID, this |
| | field stores the captured CSID from the receiving |
| | facsimile telephone device. |
| errorCode | Error code that is returned by the Dialogic telephony |
| | facsimile hardware. Zero means no error occurred. |
| | Any other value indicates no transmission occurred. |
| txDuration | The time in seconds that a facsimile telephonic |
| | certificate of insurance transmission took to transmit |
| | the certificate of insurance and accompanying |
| | documents. |
| retries | The number of times that the Dialogic telephony |
| | facsimile hardware took to successfully accomplish the |
| | telephonic facsimile transmission of the requested |
| | certificate of insurance and accompanying documents. |
| txSpeed | The BAUD rate that the Dialogic telephony facsimile |
| | hardware used to transmit the telephonic facsimile |
| | transmission of the requested certificate of insurance |
| | and accompanying documents. |
| lineNoise | The telephone line noise that the Dialogic telephony |
| | facsimile hardware encountered to transmit the |
| | telephonic facsimile transmission of the requested |
| | certificate of insurance and accompanying documents. |
| signalQuality | The telephone line signal quality that the Dialogic |
| | telephony facsimile hardware encountered to transmit |
| | the telephonic facsimile transmission of the requested |
| | certificate of insurance and accompanying documents. |
| signalStrength | The telephone line signal strength that the Dialogic |
| | telephony facsimile hardware encountered to transmit |
| | the telephonic facsimile transmission of the requested |
| | certificate of insurance and accompanying documents. |
| freeForm | A Boolean flag. If the flag is set to true, a standard |
| | ISO free written text form is inserted into the |
| | certificate of insurance prior to transmission. The text |
| | will be extracted from the freeFormText field |
| | identified below. |
| freeFormText | If the field freeForm is set to true, a standard ISO free |
| | written text form is attached to the certificate of |
| | insurance prior to transmission. The text contained in |
| | this field is graphically reproduced upon this page in |
| | the proper locations. |
| pkey | The Primary Key for this table as per ANSI 92 SQL |
| | standards for Database Management Systems (DBMS) |

The invoices table 450 stores line item credits and debits information. In one embodiment of the invention, the invoices table 450 is populated at the end of each month with a permanent record for each line item. However, the invoices table 450 is also temporarily populated with the current month's records each time a user views the agency activity report for the current month. By using the invoices table 450, the insurance agency can view its accrued invoiced activity online and up to the second in real time.

Table 6, set forth below, includes a description of each of the fields in the invoices table 450. Further, Appendix F includes exemplary data for the invoices table 450. As can be seen with reference to Appendix F, the embodiment shown includes a charge for transmitting each page of the certificate.

TABLE 6

| Field Name | Description |
|---|---|
| agencyID | The agency login ID used by the insurance agency person- |
| | nel to gain access to the certificate server. The agencyID is |
| | one of several fields that are used be the certificate server to |
| | relate the records found in the various tables of the |
| | database. |
| insuredID | The insurance agency password. The insuredID is the |
| | second of three fields that are used be the certificate server |
| | to relate the records found in the various tables of the |
| | database. |
| description | A description of this invoice line item charged to the |
| | insured and agent. This is the first column of the invoice |
| | line items. |
| quantity | Second column of the line invoice showing the quantity of |
| | this invoice line item. The value of this field is multiplied |
| | by the unit cost column's value and results in the total price |
| | of the line item derived by calculation. |
| unitCost | Third column of the line invoice showing the unit cost of |
| | this invoice line item. The value of this field is multiplied |
| | by the quantity column's value and results in the total price |
| | of the line item derived by calculation. |
| invoiceDate | The date that this invoice line item was created and |
| | recorded. |
| pkey | The Primary Key for this table as per ANSI 92 SQL |
| | standards for Database Management Systems (DBMS). |

The login attempt table 460 records data regarding those who attempt to log into the certificate server, and also records data regarding those who fail to log in. In one embodiment of the invention, after 20 bad login attempts occur on one day by any one IP address, the certificate server 110 (FIG. 1) automatically prevents that IP address from accessing the log in menus of the certificate server 110. Table 7, set forth below, includes a description of each of the fields in the login attempt table 460. Further, Appendix G includes exemplary data for the login attempt table 460.

TABLE 7

| Field Name | Description |
|---|---|
| remoteAddr | IP address of the machine of the user. |
| remoteHost | Host name of the machine of the user. |
| remoteUser | Stores the browser model number of the user. |
| loginName | The name of the user that has logged in to the system. |
| | This is filled in by the user in the login screen via the |
| | Web HTML form. |
| loginID | The login ID of the user that has logged in to the system. |
| | This is filled in by the user in the login screen via the |
| | Web HTML form. |
| password | The password of the user that has logged in to the |
| | system. This is filled in by the user in the login screen |
| | via the Web HTML form. |
| dateTimeStamp | The date and time that the user has attempted this login |
| | onto the certificate server. |
| loginSuccess | If this one byte character is the letter Y, the user |
| | successfully logged in. If the byte is the letter N, a login |
| | failure occurred. |
| pkey | The Primary Key for this table as per ANSI 92 SQL |
| | standards for Database Management Systems (DBMS). |

The hackerstatus table 470 stores the Internet Protocol (IP) address of those machines that have been used in attempted security breaches to the certificate server 100. Once a computer has had its IP address added to this file, that user may no longer access the certificate server 110. To regain access to the login screens of the certificate server 110, the user must call the system administrator or customer service personnel to request that their IP address be removed from this table in case they accidentally provide incorrect login information over 20 times. Table 8, set forth below, includes a description of each of the fields in the hackerstatus table 470. Further, Appendix H includes exemplary data for the hackerstatus table 470.

TABLE 8

| Field Name | Description |
|---|---|
| hostAddr | The host address of a user that has attempted to improperly |
| | access the certificate server. |
| pkey | The Primary Key for this table as per ANSI 92 SQL |
| | standards for Database Management Systems (DBMS). |

### Method of Operation

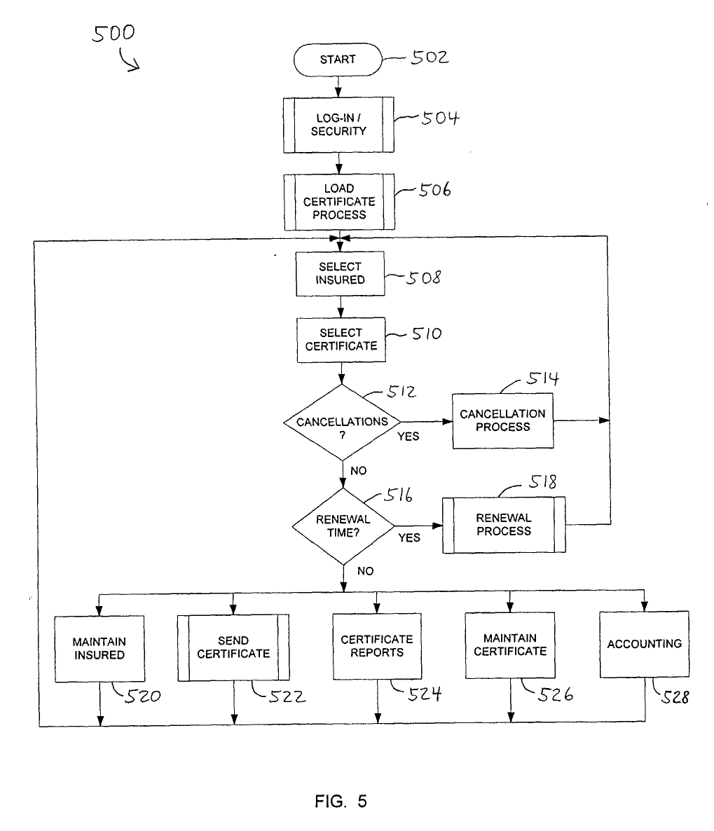

FIG. 5 is a high-level flowchart illustrating a process 500 for retrieving information and/or requesting the transmission of certificates of insurance from the certificates server 110 (FIG. 1). It is noted that both insureds and insurance agency personnel can utilize the certificate server 110 to issue a certificate and retrieve information regarding certificates that have already been issued. Therefore, for convenience of description, the term “certificate server user” is defined to include both insured and insurance agency personnel.

However, the certificate server 110 may be adapted such that selected functions of the certificate server may only be used by insurance agency personnel. For example, the certificate system 110 may be configured such that only agency personnel can select information regarding multiple insureds, whereas the insured can only look at his information. Further, for example, the certificate server 110 may be configured such that only insurance agency personnel can upload a certificate to the certificate server 110.

After starting at state 502, the certificate management system 100 proceeds to a process 504 wherein the certificate system user logs in to the certificate server 110 (FIG. 1). The process for logging in to the certificate server 110 is described below in further detail with reference to FIG. 6.

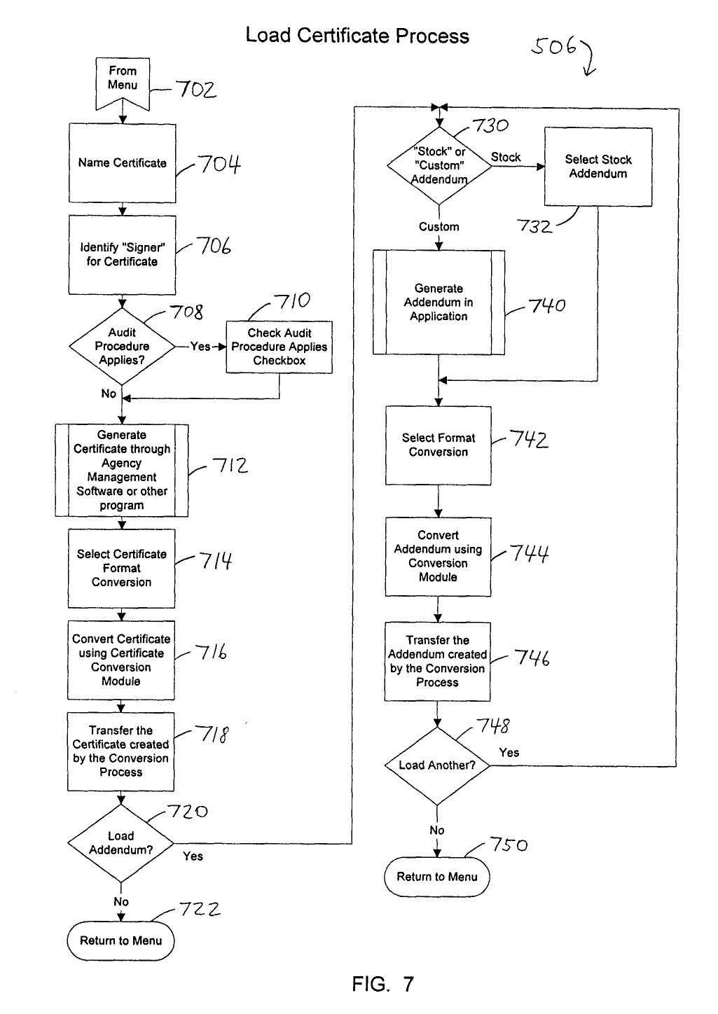

Next, at a process 506, the certificate server user loads one or more certificates of insurance to the certificate server 110. However, as discussed above, due to issues of security and trust, the certificate server 110 does not typically allow the insured to load certificates to the certificate server 110. The process for loading a certificate is described in further detail below with reference to FIG. 7.

Moving to a state 508, the certificate server user selects an insured. In one embodiment, if the certificate server user is associated with an insurance agency, the certificate server 110 allows the certificate server user to select any of the insureds that are associated with the insurance agency. However, if the certificate server user is an insured, state 508 is skipped, and the certificate server 110 automatically selects the certificate user as the insured.

Continuing to a state 510, the certificate server 110 presents a list of certificates that are associated with the selected insured. At this state, the certificate server user can select one certificate for future processing.

Proceeding to a decision state 512, the certificate server user can request the certificate server 110 to transmit notice of cancellation to one or more of the certificate holders. If the certificate server user requests cancellation, the certificate server 110 continues to a process 514, wherein the certificate server user transmits one or more certificates of cancellation to those certificate holders that have been selected by the certificate server user. Next, the certificate server 110 returns to the state 508 to allow the certificate server user to select another insured.

Referring again to the decision state 512, if the certificate server user does not desire to cancel any of the certificates, the certificate management system 100 (FIG. 1) proceeds to a decision state 516. At the decision state 516, the certificate system user can request, such as via a menu, the certificate server 110 to renew one or more of the certificates of insurance with respect to one or more of the existing certificate holders.

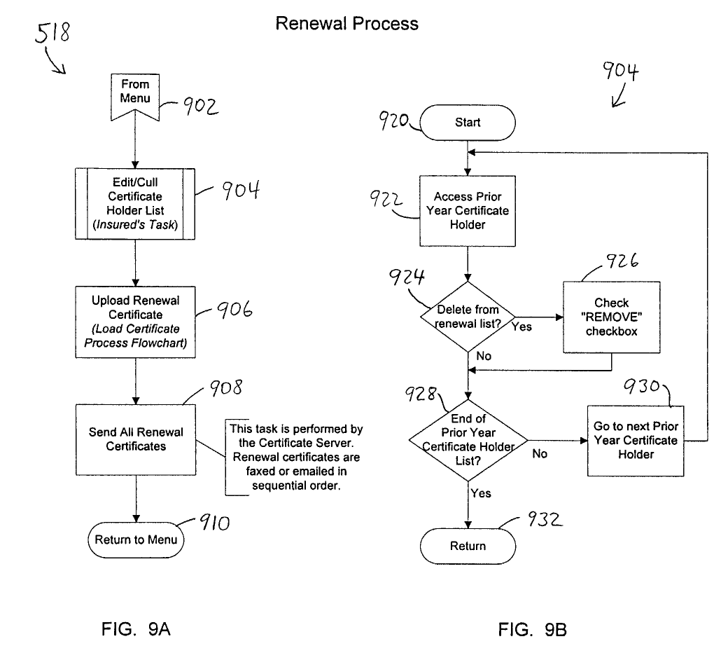

If the certificate system user requests to renew a certificate, the certificate management system 100 proceeds to a process 518. At the process 518, the certificate server 110 transmits the certificates of insurance to one or more of the certificate holders. It is noted that the process for selecting and transmitting the certificates of insurance is described below in further detail with reference to FIGS. 9A and 9B. The certificate management system 100 then returns to the state 508, and allows the certificate server user to select an new insured.

Referring again to the decision state 516, if the certificate server user decides not to renew any certificates, the certificate server user is presented with a menu which identifies one or more selectable features of the certificate management system 100. From the decision state 516, the certificate server user can proceed to one of states 520, 524, 526 or 528, or process 522.

Upon selecting the state 520, the certificate server user can perform various maintenance operations with respect to the insureds and the insured information maintained by the certificate server 110. In one embodiment of the invention, each of the insureds are not provided access to these processes. Upon selecting the state 520, the certificate server user can replace a lost password, change a password, add a new insured, or delete an insured from the certificate server 110. After completing the state 520, the certificate management system 100 returns to the state 508.

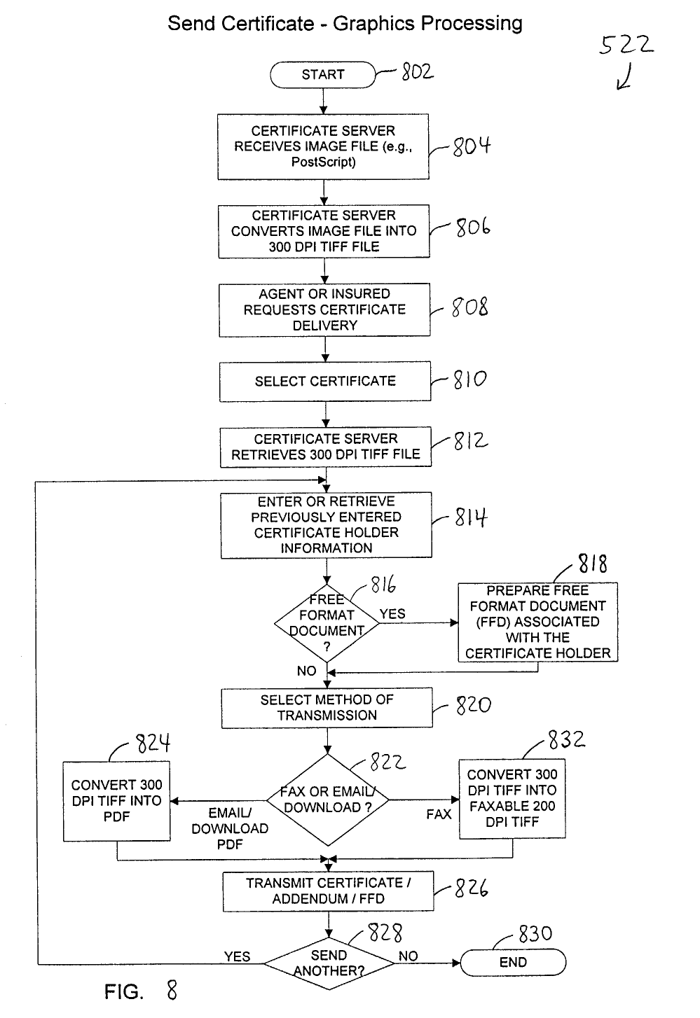

Upon selecting the state 522, the certificate server user can transmit a certificate to one or more of the certificate holders. The process for transmitting the certificate is described in further detail below with reference to FIG. 8. After completing the state 522, the certificate management system 100 returns to the state 508.

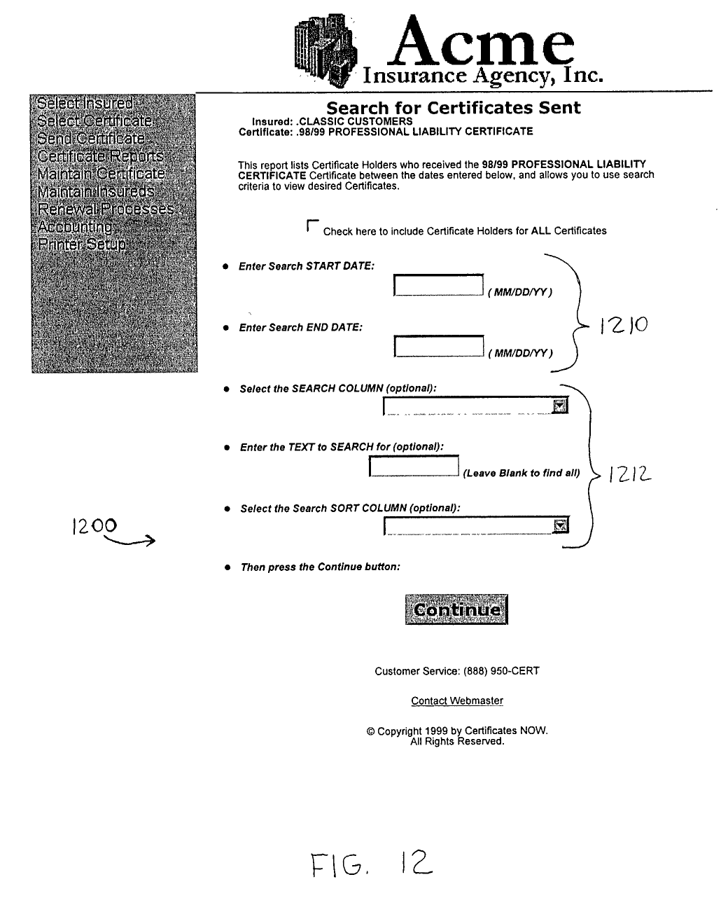

Upon selecting the state 524, the certificate server user can generate one or more reports regarding the certificates of insurance that have been issued. At the state 524, the certificate server user can view a list of certificates that have been sent, search for selected certificates, and view the currently selected certificate. FIG. 12, described in further detail below, is an exemplary screen display that may be used allow the certificate user to search for one or more issued certificates. After completing the state 524, the certificate management system 100 returns to the state 508.

Upon selecting the state 526, the certificate server user can perform various maintenance operations with respect to the certificates that are associated with the insured. At the state 526, the certificate server user can associate a certificate with an insured, edit a certificate, replace a certificate with a new certificate, or delete a certificate. Upon completing the state 526, the certificate management system 100 returns to the state 508.

Upon selecting the state 528, the certificate server user can perform various accounting operations with respect to the certificates of insurance that have issued. For example, at the state 528, the certificate server user can view the months activity in terms of issued certificates, view invoices that are now due, view previous invoices, and download information regarding the issued certificates for future processing. Upon completing the state 528, the certificate management system 100 returns to the state 508.

It is noted that depending on the embodiment, selected steps of the process 500 may be omitted or additional steps may included. For example, it is not necessary that each time a certificate server user accesses the system that a certificate of insurance be loaded (process 506). Also, for example, the certificate server user does not necessarily need to select an insured (state 508) to generate reports (state 524), maintain a certificate (state 526), or to do accounting (state 528).

Referring now to FIG. 6, the log-in/security process 504, identified in FIG. 5, will be described. This process 504 is used to prevent unauthorized use of the system 100. A user desiring to use the certificate management system 100 enters a network address, e.g., a URL, of the web site associated with the certificate server 110 (FIG. 1) in their browser. If the user is not “locked out” (as will be described below) by the certificate management system 100, a log-in screen or page is displayed on the display device of the user. If the user is locked out, the system redirects the user to a “dead end” page having a warning and instructions.

Process 504 begins at a start state 602 and moves to state 604 where an Internet Protocol (IP) address associated with the user's computer is captured and stored in the visitor table 480 (FIG. 4). Proceeding to a decision state 606, process 504 determines if the user at the captured IP address has been previously locked out from access to the web site. This determination is made by checking the hostAddr field in the hackerstatus table 470. If the user is locked out, as determined at decision state 606, process 504 continues at state 628. At state 628, process 504 redirects the user's browser to a page having a security warning and instructions to the user to become a registered user. In one embodiment, the page is a “dead end” page coded in HTML.

However, if the user is not locked out, as determined at decision state 606, the process 504 continues at state 608. The user's browser is directed to a log-in page where the user is prompted to enter a user name and password or other identification and security information. At state 608, the process 504 checks the entered user identification and security information. If the information is determined to be valid, as determined at a decision state 610, process 504 proceeds to state 612. At state 612, the browser of the authenticated user is then directed to the next screen of the certificate web site and process 504 completes at an end state 614.

Referring again to the decision state 610, if the entered user identification and security information is not valid, the process 504 advances to a decision state 616. At decision state 616, process 504 determines if the IP address captured at state 604 is new, i.e., that the IP address has not been previously captured and stored by the process 504. If the IP address is new, process 504 moves to state 618 and initializes a variable “count” for the captured IP address to a value of one. Process 504 continues at a decision state 620 to check if the user has stopped entering log-in information, i.e., user identification and security information, within a predetermined time interval, e.g., 15 minutes. If the user has stopped log-in attempts, as determined at decision state 620, process 504 deems that the user has abandoned trying to log-in and completes at an end state 622.

However, if the user enters another user name and password, i.e., the user has not stopped log-in attempts as determined at decision state 620, process 504 continues at state 608 to check the entered log-in information. If the information is not valid, as determined at decision state 610, process 504 proceeds to decision state 616 to determine if the IP address is new and whether the count variable has been established for the IP address. On a second or subsequent log-in attempt for a particular IP address, the count variable is established and process 504 continues at state 624. At state 624, the count variable for the current IP address is incremented by one. Process 504 then moves to a decision state 626 to determine if the value of count for the current IP address is greater than a predetermined value of a variable N. In one embodiment, the value of N is twenty. If the value of count is not greater than the value of N, process 504 moves to decision state 620 to determine if the user has stopped log-in attempts as previously described. However, if the value of count is greater than the value of N, as determined at decision state 626, process 504 advances to state 628. At state 628, the user at the current IP address is locked out from further use of the certificate server web site. This is noted by recording the host address of the user in the hackerstatus table 470. In one embodiment, the user's browser is redirected to a dead-end page having a security warning and instructions to the user to become a registered user. Process 504 completes at the end state 622.

Referring now to FIG. 7, the load certificate process 506, identified in FIG. 5, will be described. This process 506 is used to generate an insurance certificate at an agency computer, such as computer 120 (FIG. 2), and transfer the certificate to the certificate server 110. An exemplary certificate is shown in FIG. 13. In one embodiment, the certificate that is generated includes all the portions of the certificate, such as policy information 1310 (FIG. 13), other than the date 1306, certificate holder information 1314, and a signature 1316. Optionally, an addendum to the certificate may be generated by process 506.

Process 506 begins because of selection from the menu at state 702, and moves to state 704 where the user names the insurance certificate that will be generated. An example of a certificate name may be “98/99 Premises Liability Certificate.”

Proceeding to state 706, the user identifies the name of the person who will be the “signer”, e.g., an authorized representative of the agency, of the certificate. Continuing at a decision state 708, a determination is made whether an audit procedure applies for the current certificate that is to be generated. If so, an audit procedure applies checkbox is marked to so indicate.

Certain insurance agency errors and omissions insurance carriers may require that an agency provide documentation of certificates issued, to the carrier represented on the certificate as part of an audit procedure. This may be typically done by mailing copies of all the issued certificates having the certain policy type(s) to the carrier on a regular basis, e.g., monthly. Accumulating paper copies of issued certificates for say a month and mailing them to the carrier is time consuming and wasteful of resources.

By checking the audit procedure applies checkbox, the certificate management system 100 identifies the current certificate to be electronically tracked and saved for an automated audit procedure. Later, as names of certificate holders are entered into the system 100, the automated audit procedure tracks and records all the recipients of the current certificate. Then, when the insurance carrier requires documentation from the agency, an electronic image of the certificate and a list of recipients of the certificate is transferred to the agency, carrier or other entity, such as by e-mail, fax or downloading in order that the carriers represented thereon maybe notified. This automated audit procedure is thus more time efficient and conserving of resources. It is noted, that the certificate server 110 can be requested to always perform an audit procedure with respect to all of the insureds that are associated with an agency or to always apply an audit procedure to a selected insured.

If the audit procedure does not apply, as determined at decision state 708, or at the completion of state 710, process 506 advances to a generate certificate state 712. State 712 may utilize the agency management program 220 (FIG. 2) or other software to generate an electronic insurance certificate. As described above, in one embodiment, the certificate does not include the date, certificate holder information, and the signature, and therefore, may be considered a partially completed or pro forma certificate.

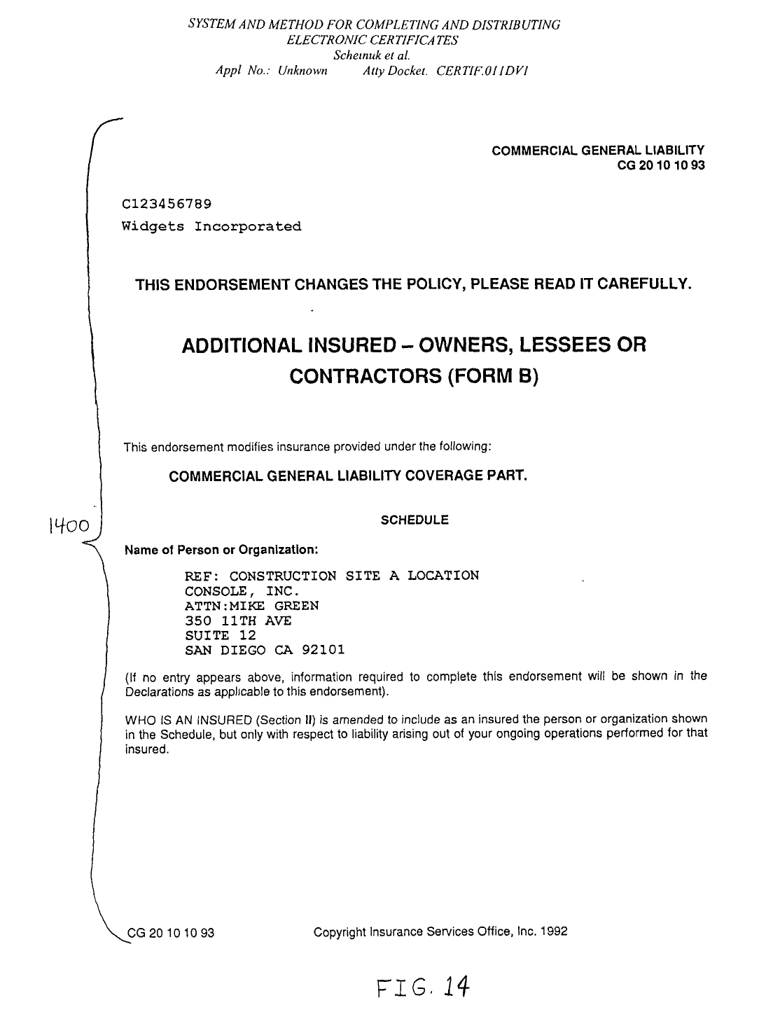

At the completion of state 712, process 506 advances to state 714 where the user selects certificate format conversion. Moving to state 718, process 506 executes the certificate conversion module software. The certificate conversion module software may be a plug-in program, a Java applet, or other type of software. In one embodiment, the result of executing the certificate conversion module is an image file of the partially completed or pro forma certificate. In another embodiment, the result of executing the certificate conversion module is data that that specifies the form and content of a certificate. Further, in one embodiment, the module may execute a software program to convert the certificate by use of a Windows printer driver to generate an image file rather than printing the certificate. The image file may be in a tag image file (TIF) format, a PostScript format, or in another well known image format. In one embodiment, the image file is stored on a hard drive or other mass storage device of the agency computer 120 (FIG. 2) in the file system of the operating software, e.g., Windows. After the certificate is converted at state 716, process 506 continues at state 718 where the converted certificate, e.g., an image file, is transferred from the agency computer 120 to the certificate server 110 (FIG. 2) via the network 114 (FIG. 1) as previously described. After the converted certificate is transferred at state 718, process 506 continues at a decision state 720 to determine if an addendum to the certificate is necessary. An exemplary addendum is shown in FIG. 14. If the addendum is not necessary, process 506 completes and returns to the menu at state 722.

However, if an addendum is desired, as determined at decision state 720, process 506 proceeds to a decision state 730 to determine if a “stock” or if a “custom” addendum is to be used. If a custom addendum is to be used, process 506 proceeds to a function 740 where the custom addendum is generated by use of the agency management computer 120 (FIG. 2) or an application program (not shown). The application program may be a word processing program, a spreadsheet program, a desktop publishing program or other similar application program. If a stock or standard addendum is to be used, process 506 proceeds to state 732 where the user selects one of a plurality of stock addenda.

At the completion of state 732 or of function 740, process 506 proceeds to state 742 where the user selects format conversion. Moving to state 744, process 506 executes the conversion module software. In one embodiment, the result of executing the conversion module is an image file of the addendum. In one embodiment, the module may execute a software program to convert the addendum by use of a Windows printer driver to generate an image file rather than printing the addendum. The image file may be in a TIF format, a PostScript format, or in another well known image format. In one embodiment, the image file is stored on a hard drive of the agency computer 120 in the file system of the operating software. After the addendum is converted at state 744, process 506 continues at state 746 where the converted addendum, e.g., an image file, is transferred from the agency computer 120 to the certificate server 110 (FIG. 2) via the network 114 (FIG. 1). After the converted addendum is transferred at state 746, process 506 continues at a decision state 748 to determine if another addendum needs to be processed and loaded to the certificate server 110. If so, process 506 moves to decision state 730 to determine if a “stock” or if a “custom” addendum is to be used as previously described. If no further addendum needs to be loaded to the certificate server 110, as determined at decision state 748, process 506 completes and returns to the menu at state 750.

In another embodiment, a plurality of stock addenda are prestored in the image database 250 connected to the certificate server 110. When a stock addendum is selected at state 732, an identifier of the selected prestored stock addendum is associated with the current certificate so that the conversion and transfer steps 742-746 are not necessary.

Referring now to FIG. 8, the send certificate process 522, identified in FIG. 5, will be described. This process 522 is used to perform the graphics processing so as to send the certificate(s), optional addenda, and/or free form documents to a certificate holder.

Process 522 begins at a start state 802 and moves to state 804 where the certificate server 110 (FIG. 2) receives an image file, e.g., file 226 (FIG. 2), generated by the load certificate process 506 (FIG. 7). The image file may be representative of a certificate or an addendum, and may be in a PostScript, or other well-known graphics file format Proceeding to state 806, in one embodiment, the certificate server 110 converts the received image file into a predetermined graphics format and resolution, such as, for example, a 300 dpi TIF format. In one embodiment, the image file is stored in the image database 250 (FIG. 2). Of course, other graphic resolutions and formats may alternatively be utilized. Alternatively, in another embodiment, the received image file may be retained in its original format instead of being converted as in state 806.

Continuing at state 808, an agent/broker or an insured requests delivery of an insurance certificate and selects a particular certificate that has been loaded to the certificate server 110 at state 810. Advancing to state 812, the certificate server 110 retrieves the converted image file from the image database 250. Moving to state 814, the agent or the insured may enter certificate holder information which is sent to the certificate server 110 via path 228 or path 229 (FIG. 2), respectively. Alternatively, the agent or insured may retrieve previously entered certificate holder information from the certificate server database 240. In either case, the certificate holder information 1314 (FIG. 13) is merged with the converted image, and the current date 1306 and signer information 1316 is also merged to generate a final certificate.

Proceeding to a decision state 816, process 522 determines if the user desires to include a free format document with the completed certificate. In one embodiment, the free format document is associated with a particular certificate holder. The free format document may list the property owners or additional insureds for a particular project, for example. If a free format document (FFD) is desired, as determined at decision state 816, process 522 advances to state 818 where the user generates the FFD. Process 522 correlates the FFD with the certificate holder information entered or retrieved in state 814.

At the completion of generating the FFD at state 818 or if a FFD is not desired, as determined at decision state 816, process 522 continues at state 820. At state 820, the user selects a desired method of transmission of the completed certificate, addendum and/or FFD, such as, for example by facsimile, e-mail, or download. Proceeding to a decision state 822, process 522 determines the desired method of transmission. If the user desires to utilize e-mail or download capability, process 522 moves to state 824 wherein the appropriate files (completed certificate, addendum, FFD) are converted from the 300 dpi TIF format to a portable document format (PDF), for example. Of course other format conversions are possible and are envisioned. If the user desires to utilize facsimile capability, process 522 moves to state 832 wherein the appropriate files (completed certificate, addendum, FFD) are converted from the 300 dpi TIF format to a faxable 200 dpi TIF format, for example.

At the completion of the format conversion at state 824 or state 832, process 522 moves to state 826 and transmits the converted document file(s) by the method selected at state 820. After the documents are transmitted at state 826, process 522 advances to a decision state 828 to determine if the user desires to send the certificate to another certificate holder. If so, process 522 moves back to state 814 where new certificate holder information is entered or retrieved, as previously discussed. If no further certificates are to be sent, as determined at decision state 828, process 522 completes at an end state 830.

FIG. 9A is a high level flowchart illustrating a process for renewing one or more certificates of insurance. FIG. 9A shows in further detail the acts that occur in process 518 of FIG. 5.

After selecting the renewal process, such as via a menu, the certificate server 110 proceeds to a state 904. At the state 904, the user is afforded an opportunity to modify a certificate holder distribution list that contains the names of each of the certificates holders that have received the selected certificate (state 508 of FIG. 5). The process for editing the certificate holder list is described below in further detail with reference to FIG. 9B.

Continuing to a state 906, the user uploads a renewal certificate to the certificate server 110 (FIG. 1). The process for loading a certificate is described above with reference to FIG. 7. Next, at a state 908, the certificate server 110 transmits the renewal certificates to each of the certificate holders identified by the certificate holder list. The default is to send to location PRIOR YEAR. The certificate server 110 can, depending on the requestor's preferences, transmit the renewal certificates via, fax, e-mail, or download. Next, at a state 910, the process returns to state 508 of FIG. 5. In one embodiment, the certificate server 110 is set to automatically transmit the renewal certificate using the transmission method that was last used to transmit the certificate.

FIG. 9B is a flowchart illustrating in further detail the acts that occur in state 904 of FIG. 9A. FIG. 9B describes the process by which a user removes one or more certificate holders from the renewal list. After starting at state 920, the certificate server 110 (FIG. 1) proceeds to a state 922 wherein the certificate server 110 displays to the user (FIG. 1) one of the current certificate holders. Next, at a decision state 924, the certificate server determines whether the user wants to delete the certificate holder from the renewal list. At this decision state, in one embodiment, the certificate server 110 displays a remove checkbox proximately to the name of the certificate holder. If the user does not want to send a renewal certificate to the certificate holder, the user checks the remove checkbox using an input device and the certificate server 110 proceeds to a state 926.

The certificate server 110 (FIG. 1) proceeds to a decision state 928 if the user decides not to remove the certificate holder from the certificate holder list or after the user has selected the remove checkbox. At the state 928, the certificate server 110 determines whether there are any additional certificate holders that remain unprocessed. If there are additional certificate holders, the certificate server 110 proceeds to a state 930 wherein the certificate server 110 selects the next certificate holder for display to the user. Next, the certificate server 110 returns to the state 922 to repeat the process for determining whether the user want to transmit a renewal certificate to the selected certificate holder.

Referring again to the decision state 928, if the certificate server 110 determines that each of the certificate holders have been processed, the certificate server returns at state 932 to state 906 of FIG. 9A. It is noted that in one embodiment of the invention, a certificate holder list is presented to the user, wherein the list includes the names of each of the certificate holders that are to receive a renewal certificate. In this embodiment, a remove checkbox is displayed proximate to the name of each of the certificate holders. If the user desires to not transmit a renewal certificate, the user selects the remove checkbox that is proximate to the names of the certificate holders.

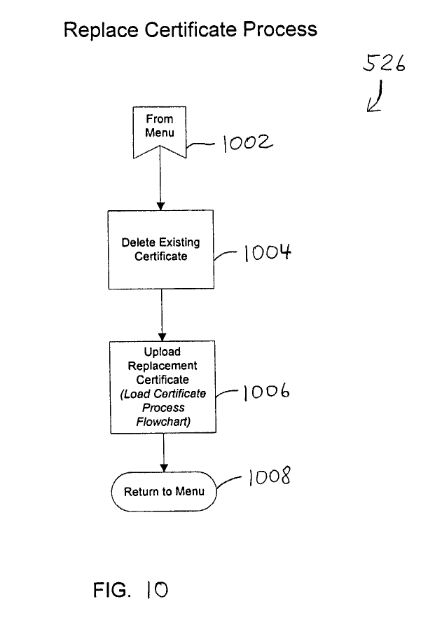

FIG. 10 is a high level flowchart for replacing one certificate with another. FIG. 10 illustrates in further detail the actions that are performed in state 526 of FIG. 5 with respect to replacing a certificate. After starting at a state 1002, the certificate server 110 proceeds to a state 1004. At the state 1004, the user confirms that they would like to replace the currently selected certificate. Next, at a state 1006, the certificate server 110 requests the user to upload a replacement certificate. Once the certificate has been uploaded, the process returns at state 1008 to the state 508 (shown in FIG. 5).

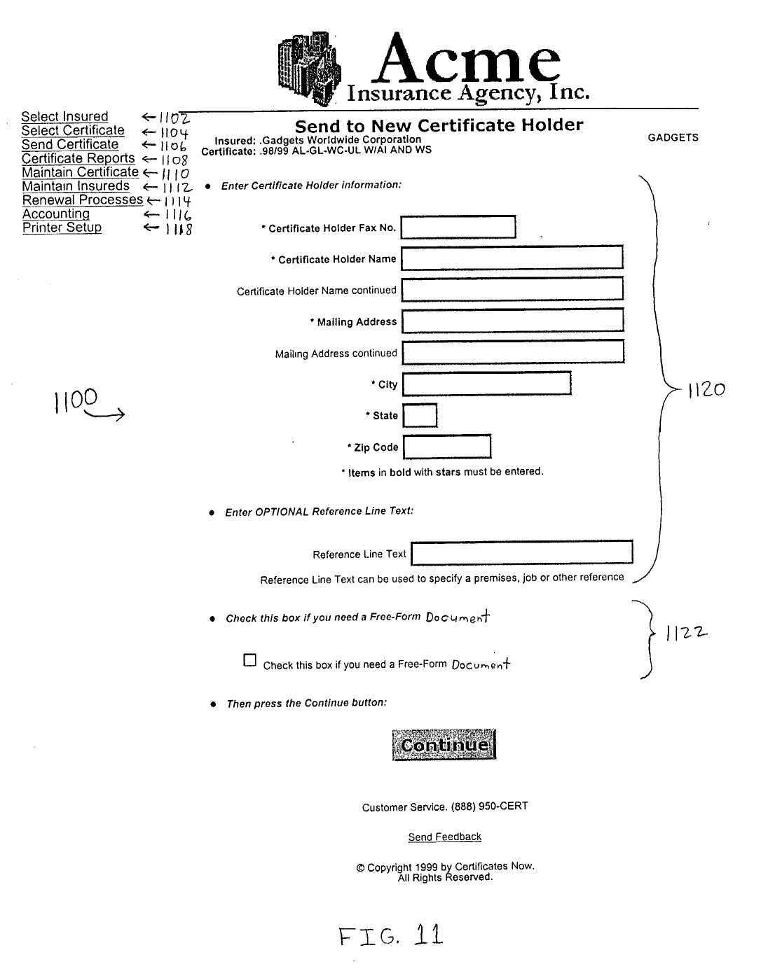

FIG. 11 is a screen display 1100 that is generated by the certificate server 110 during the send certificate process 522 shown in FIG. 8. The screen display 1100 includes one or more input fields to allow the user to input contact information 1120 regarding a certificate holder. In one embodiment of the invention, the contact information 1120 includes the fax number of the certificate holder, the name of the certificate holder, the address of the certificate holder, the address of the certificate holder, the state, the city, and the zip code of the certificate holder. Further the screen display includes a checkbox 1122 which allows a user to associate a free form document to a selected certificate. The free form document is described above in further detail with reference to FIG. 8. The screen display 1100 also includes a plurality of menu selections 1102-1118 to allow the user to select one or more of the functions provided by the certificate server 110.

FIG. 12 is an exemplary screen display 1200 that may be used to allow a user to search for one or more certificates that have been issued by the certificate server 110. The screen displays 1200 includes one or more date fields 1210 which allow the user to select a particular time period. Further, the screen display 1200 includes miscellaneous input fields 1212 which allow the user to search the issued certificates via various types of search criteria, such as by the text that is contained within the certificates of insurance.

FIG. 13 illustrates an exemplary certificate 1300 that has been issued by the certificate server 110. The certificate 1300 includes an agency 1302, an insured section 1304, a date section 1306, a carrier section 1308, a coverage section 1310, a description section 1312, a certificate holder section 1314, and a signature section 1316.

The agency section 1302 includes the name and address of the insurance agency that issued the certificate. The insured section 1304 includes the name and address of the insured that owns the insurance policy for which the certificate has issued. The date section includes a date which identifies the date that the certificate issued. The carrier section 1308 includes the name of the insurance carriers that are carrying one or more of the policies. The coverage section 1310 include the policy information of the insured identified by the insured section 1304. The description section 1312 includes a written description regarding one or more aspects of the insurance policy. The certificate holder section 1314 includes the name and address of the certificate holder to whom the certificate has issued. The signature section 1316 includes the name of the insurance agent or authorized representative at the insurance company in the agency section 1302 that issued the certificate.

In one embodiment of the certificate management system 100, the agency section 1302, the insured section 1304, the carrier section 1308, the coverage section 1310, and the description section are completed by the insurance agent prior to the certificate being uploaded to the certificate server. In this embodiment, upon a request from the user, the date section 1306, the certificate holder information 1314, and the signature section 1316 are inserted into the certificate immediately before transmission to the certificate holder.

FIG. 14 illustrates an exemplary addendum 1400. As was discussed above, the addendum is one or more extra pages that are associated with a certificate and that contain extra policy provisions which should be provided by the insurance agency to the certificate holder.

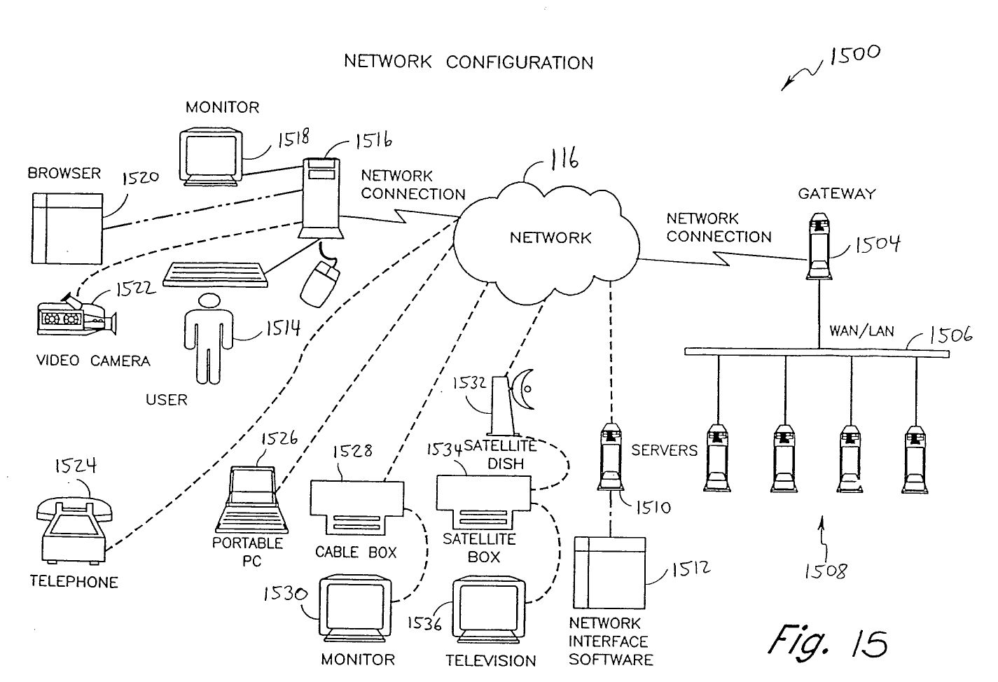

Referring to FIG. 15, an exemplary network configuration will be described. An agency or insured user 1514 communicates with a computing environment which may include a single server or may include multiple servers in a client/server relationship on a computer network. In a client/server environment, the server includes the certificate program which communicates with a client that may include a network terminal equipped with a video display, keyboard and pointing device. The network terminal may be connected to a wide area network via a network connection, which may be either a dial-up connection using a modem and the public switched telephone network (PSTN) or via a dedicated data circuit. The wide area network can be a public network, like the Internet, or a closed, private data network, like a corporate network or an intranet. There maybe an array of servers which host the certificate application and databases at a central location. These servers maybe connected via a local area network to a network gateway, which provides access to the wide area network via a high-speed, dedicated data circuit. Alternatively, a single server may host the certificate applications and databases.

The networked certificate system 1500 may include the Internet “cloud” 116, which may represent a local area network (LAN), a wide area network (WAN), the Internet, or another connection service. The certificate program and databases may reside on a group of servers 1508 that may be interconnected by a LAN 1506 and a gateway 1504 to the network 116. Alternatively, the certificate program and databases reside on a single server 1510 that utilizes network interface hardware and software 1512. The network 116 may connect to a user computer 1516, for example, by use of a modem or by use of a network interface card. The user 1514 at computer 1516 may utilize a browser 1520 to remotely access the certificate program using a keyboard and/or pointing device, an optional video camera 1522 and a visual display, such as monitor 1518.

Various other devices may be used to communicate with the certificate servers 1508/1510. If the servers are equipped with voice recognition or DTMF hardware, the user can communicate with the certificate program by use of a telephone 1524. Other connection devices for communicating with the certificate servers 1508/1510 include a portable personal computer 1526 with a modem or wireless connection interface, a cable interface device 1528 connected to a visual display 1530, or a satellite dish 1532 connected to a satellite receiver 1534 and a television 1536. Other ways of allowing communication between the user 1514 and the certificate servers 1508/1510 are envisioned.

Advantageously, the certificate server 110 of the present invention allows a insurance agent to upload one or more certificates of insurance for an insured. Once uploaded, an insured can request the certificate server to automatically transmit the certificate, any addenda that are associated with the certificate, and a free form document to a certificate holder. The certificate management system 100 eliminates the dual-entry problems that are inherent in traditional insurance systems. Further, the certificate system 100 allows for the automatic transmission of renewal certificates to current certificate holders. The certificate server 100 allows for the transmission of certificates via e-mail, facsimile or downloading.

The certificate server 110 also maintains accounting information with respect to each of the issued certificates. The certificate server 110 can generate reports which describe the number of certificates that have been issued by an insured and the total cost of issuing such certificates.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

### Appendix Overview

Appendixes A-I contain exemplary data for the database schema 240′ shown in FIG. 4. It is noted that due to space limitations, Appendixes A, C, D, and E have each been vertically partitioned into several sections. Appendix A includes exemplary data for an agency table 400. Appendix B includes exemplary data for a clients table 410. Appendix C includes exemplary data for the clientfaxlist table 420. Appendix D includes exemplary data for the addendum table 430. Appendix E includes exemplary data for the faxes table 440. Appendix F includes exemplary data for the invoices table 450. Appendix G includes exemplary data for the loginattempt table 460. Appendix H includes exemplary data for the hackerstatus table 470. Appendix I includes exemplary data for the visitors table 480.

[image]

[image]

[image]

[image]

[image]

[image]

[image]

[image]

[image]

[image]

What is claimed is:

1. A system for generating insurance certificates, the system comprising:
a first database comprising policy data items that are associated with policy information for a plurality of insureds;
an agency computing device which receives policy data items, from the first database, and a digital representation of an insurance certificate form, wherein the agency computing device inserts one or more policy data items in the digital representation of the insurance certificate form to generate an electronic insurance certificate for each insured;
a computer network connected to the agency computing device;
a client computing device connected to the computer network; and
a certificate server connected to the client computing device via the computer network, wherein the certificate server maintains one or more electronic insurance certificates received from the agency computing device, wherein, upon a request from the client computing device, the certificate server merges one or more certificate holder information items regarding a certificate holder with a corresponding electronic insurance certificate to produce a completed insurance certificate, and wherein the certificate server automatically transmits the completed insurance certificate to the certificate holder.

2. The system of claim 1, wherein the certificate holder information items include the name and address of the certificate holder.

3. The system of claim 1, wherein the certificate holder information items are obtained from the client computing device.

4. The system of claim 1, wherein the certificate holder information items are obtained from the certificate server.

5. The system of claim 1, wherein the certificate server additionally merges a signature of an agency representative and a date of issuing the completed insurance certificate with the corresponding electronic insurance certificate.

6. The system of claim 1, wherein the electronic insurance certificate including the policy data items comprises a pro forma certificate.

7. The system of claim 1, wherein the certificate holder information items are obtained from the first database of policy data items.

8. The system of claim 1, wherein the certificate holder information items are obtained from the agency computing device.

9. The system of claim 1, wherein the client computing device is located remote from the location of the certificate server and from the location of the certificate holder.

10. The system of claim 9, wherein the client computing device is located at an insurance agency.

11. The system of claim 1, wherein the client device comprises a network browser, and wherein the network browser requests the certificate holder information items to be merged with a corresponding electronic insurance certificate.

12. The system of claim 9, wherein the certificate server maintains a second database of a plurality of insurance agencies, and wherein each agency is associated with a plurality of insureds.

13. The system of claim 12, wherein the second database includes certificate holder information.

14. The system of claim 13, wherein the certificate holder information items are obtained from the second database.

15. The system of claim 9, wherein the client computing device is located at an insured location.

16. The system of claim 1, wherein the certificate server automatically transmits the completed insurance certificate to the client computing device in response to a request from the client computing device.

17. The system of claim 1, wherein the client computing device comprises a computer.

18. The system of claim 1, wherein the client computing device comprises a facsimile machine.

19. The system of claim 1, wherein the client computing device comprises a handheld computer.

20. The system of claim 1, wherein the client computing device is operated by an insured.

21. The system of claim 1, wherein the certificate server automatically transmits the merged insurance certificate via electronic mail.

22. The system of claim 1, wherein the computer network connection is included in a virtual private network.

23. The system of claim 1, additionally comprising a third database, in data communication with the certificate server, configured to store the electronic insurance certificates.

24. The system of claim 1, wherein, upon a user request, the certificate server identifies one or more of the insurance certificates and transmits certificate information regarding each of the identified certificates to the client computing device.

25. The system of claim 24, wherein one or more of the insurance certificates are identified as satisfying a search criteria.

26. The system of claim 25, wherein the search criteria includes a start date and an end date.

27. The system of claim 25, wherein the search criteria includes a text string.

28. The system of claim 1, wherein the certificate server is configured for storing a selected electronic insurance certificate and a corresponding list of recipients of the selected electronic insurance certificate.

29. The system of claim 28, additionally comprising a program module executed on the certificate server, the program module configured to transmit the list of recipients and the selected electronic insurance certificate to an insurance carrier.

30. The system defined in claim 29, wherein the program module transmits the selected electronic insurance certificate and the list of recipients via the Internet.

31. The system defined in claim 29, wherein the program module transmits the selected electronic insurance certificate and the list of recipients via a telephone network.

32. The system defined in claim 29, wherein the program module transmits the selected electronic insurance certificate and the list of recipients via a wide area network.

33. The system of claim 28, wherein the corresponding list of recipients of the selected electronic insurance certificate is accumulated during a predetermined time interval.

34. The system of claim 28, wherein the selected electronic insurance certificate is selected to be audited from a plurality of electronic insurance certificates.

35. The system of claim 1, additionally comprising a first software module executed on the certificate server, the first software module configured to accumulate recipient identifiers of a selected electronic insurance certificate over a selected time interval into a list.

36. The system of claim 35, additionally comprising a second software module executed on the certificate server, the second software module configured to transmit the list of recipients identifiers and the selected electronic insurance certificate.

37. The system of claim 35, wherein the predetermined time interval is a month.

38. The system of claim 35, wherein the insurance certificate is selected based on insurance carrier criteria.

39. The system of claim 38, wherein the criteria comprises a type of insurance policy.

40. A system for generating insurance certificates, the system comprising:
a computer network;
an agency computing device connected to the computer network and configured to insert one or more policy data items that are associated with policy information for a plurality of insureds in a digital representation of an insurance certificate form to generate an electronic insurance certificate for each insured;
a client computing device connected to the computer network; and
a certificate server connected to the client computing device via the computer network, wherein the certificate server maintains one or more of the electronic insurance certificates received from the agency computing device, wherein, upon a request from the client computing device, the certificate server merges one or more certificate holder information items with a corresponding electronic insurance certificate to produce a completed insurance certificate, and wherein the certificate server automatically transmits the completed insurance certificate to the certificate holder.

41. The system of claim 40, wherein the certificate holder information items are obtained from the client computing device.

42. The system of claim 40, wherein the certificate holder information items are obtained from the agency computing device.

43. The system of claim 40, wherein the certificate holder information items are obtained from a first database in data communication with the certificate server.

44. The system of claim 40, wherein the certificate holder information items are obtained from a second database in data communication with the agency computing device.

45. The system of claim 40, wherein the certificate holder information items include the name and address of the certificate holder.

46. The system of claim 40, wherein the certificate server additionally merges a signature of an agency representative and a date of issuing the completed insurance certificate with the corresponding electronic insurance certificate.

47. The system of claim 40, wherein the client computing device is located remote from the location of the certificate server and from the location of the certificate holder.

48. A system for generating insurance certificates, the system comprising:
a computer network;
a client computing device connected to the computer network, and configured to provide certificate holder information; and
a certificate server connected to the client computing device via the computer network, and configured to provide certificate holder information, wherein the certificate server maintains one or more electronic insurance certificates, wherein, upon a request from the client computing device, the certificate server merges one or more certificate holder information items with a corresponding electronic insurance certificate to produce a final insurance certificate, and wherein the certificate server automatically transmits the final insurance certificate to the certificate holder.

49. A method of generating insurance certificates, the method comprising:
providing an electronic insurance certificate form;
inserting one or more policy data items that are associated with policy information for an insured in the electronic insurance certificate form to generate an electronic insurance certificate;
storing the electronic insurance certificate in a first database;
merging one or more certificate holder data items that are associated with a certificate holder with the electronic insurance certificate to generate a completed insurance certificate; and
transmitting the completed insurance certificate to a certificate holder at a remote location via a network.

50. The method of claim 49, additionally comprising receiving a request from the insured to perform the merging and transmitting.

51. The method of claim 49, additionally comprising receiving the one or more certificate holder data items that are associated with a certificate holder from the insured.

52. The method of claim 49, additionally comprising obtaining the one or more certificate holder data items that are associated with a certificate holder from a second database.

53. The method of claim 49, wherein the electronic insurance certificate comprises a pro forma certificate.

54. The method of claim 49, additionally comprising searching for insurance certificates by the insured, comprising:
receiving a request from the insured for one or more insurance certificates satisfying a search criteria;
identifying one or more of the insurance certificates that satisfy the search criteria; and
transmitting information regarding each of the identified insurance certificates to a client computer at a remote location from the location of the stored electronic insurance certificates.

55. The method of claim 54, wherein the client computer is operated by the insured.

56. The method of claim 54, wherein the search criteria includes a start date and an end date.

57. The method of claim 54, wherein the search criteria includes a text string.

58. The method of claim 49, additionally comprising auditing a plurality of insurance certificates, comprising:
a) selecting a particular insurance certificate to be audited;
b) tracking recipients of the selected insurance certificate in a list for a predetermined time interval;
c) storing the list of recipients; and
d) transmitting the selected insurance certificate and the list of recipients.

59. The method of claim 58, wherein the selected insurance certificate and the list of recipients is transmitted to an insurance carrier.

60. The method of claim 58, wherein the predetermined time interval is a month.

61. The method of claim 58, wherein the insurance certificate is selected based on insurance carrier criteria.

62. The method of claim 61, wherein the insurance carrier criteria comprises a type of insurance policy.

63. The method of claim 58, wherein a)-c) are repeated for a different insurance certificate during the same predetermined time interval.

64. The method of claim 58, wherein a)-c) are repeated for a different insurance certificate during a different predetermined time interval.

65. The method of claim 49, additionally comprising associating a digital document with the completed insurance certificate.

66. The method of claim 65, wherein the digital document contains information associated with the certificate holder.

67. The method of claim 49, wherein the completed insurance certificate cannot be modified after the transmitting.
